(19) United States
(12) Patent Application Publication
(10) Pub. No.: US 2010/0174603 A1
(43) Pub. Date: Jul. 8, 2010

(54) System and Method for Advertising Placement and/or Web Site Optimization

(76) Inventors: Robert Hughes, Marlborough, CT (US); John M. Hughes, Hebron, CT (US)

Correspondence Address: Goodwin Procter LLP, Patent Administrator, 53 State Street, Boston, MA, 02109-2881, US

(21) Appl. No.: 12/578,949

(22) Filed: Oct. 14, 2009

Related U.S. Application Data
(60) Provisional application No. 61/105,114, filed on Oct. 14, 2008.
(60) Provisional application No. 61/105,112, filed on Oct. 14, 2008.

(51) Int. Cl. G06Q 30/00; G06Q 90/00; G06F 3/01; G06F 15/16

(52) U.S. Cl. 705/14.42; 705/1.1; 705/500; 715/760; 709/203

(57) ABSTRACT

In general, in one aspect, a method for web site optimization includes publishing performance statistics of task performers, facilitating selection of task performers for participation in a competition based on the published performance statistics, facilitating optimization by each selected competitors, collecting response to the optimization of each selected competitor, updating the published performance statistics based on the response; and compensating the task performers based on the published performance statistics. In some embodiments, a prize is awarded to the task performer with the best performance. In some embodiments, a competition is conducted for the design of web site content to be optimized.

### RELATED APPLICATIONS

This application claims priority to and the benefit of U.S. Provisional Patent Application Ser. No. 61/105,112, filed on Oct. 14, 2008, entitled “SYSTEM AND METHOD FOR ADVERTISING PLACEMENT,” attorney docket number TOP-024PR, and U.S. Provisional Patent Application Ser. No. 61/105,114, filed on Oct. 14, 2008, entitled “SYSTEM AND METHOD FOR WEB SITE OPTIMIZATION,” attorney docket number TOP-026PR.

### TECHNICAL FIELD

This invention relates to computer-based methods and systems for facilitating the placement of advertising on web sites and web sites on search engine results.

### BACKGROUND INFORMATION

The internet allows for placement of advertising on web sites, and for measurement of the response of viewers to the advertising. In some cases, advertisements may be placed using an advertising network or aggregator, in which sites or types of sites may be selected and advertising space purchased in aggregate. In some cases, advertisements may be placed through direct purchase from a site. In some cases, keywords for searches or for content may be specified, so that the customer's advertisements are shown in connection with particular content. GOOGLE ADWORDS is an example of this type of advertising purchase. Some ad placement is “pay per click,” which means that the advertiser only pays for users that “click” on the advertisement.

It often is not straightforward, however, for a company to identify the best advertising provider, or the ad placement strategy that will have the best results and yield the most value. Some ad placers, companies and/or individuals who specialize in ad placement, offer a service of identifying sites and/or purchasing advertisements for their customers. It often is difficult, however, to fairly compare the results of various ad placers, or to identify which ad placer can achieve best results and value.

Search engines are the primary way that internet users locate web sites. It can be beneficial for web site owners, particularly commercial web site owners, to take steps to increase the likelihood that search engine users find their web site.

Search optimization is the process of editing and organizing content on a webpage or across a website or web sites to increase the volume of targeted traffic from search engines. Search optimization is an important web marketing activity and can target different kinds of searches, including word search, image search, local search, and industry-specific search. Optimizers typically consider how search engines work and what people search for. Optimizing a website typically involves, for example, editing its content and HTML coding to both increase its relevance response to specific keyword searches and to remove barriers to the indexing activities of search engines. Sometimes a site's structure may be edited as well.

Optimizing a web site for search engine response can be a difficult task. The New York Times reported, for example, that the Google search engine takes into account more than 200 different types of information to determine search engine results. It can be beneficial to find optimizers who are skilled at optimizing a site in the manner desired by the site owner. It is at present, however, difficult to locate skilled optimizers and to obtain specific information about the performance of site optimizers.

Likewise, it can be difficult to determine how to optimize a web site to maximize specific user behavior, once the user is on the site. For example, to maximize revenue generated by visitors to the site.

### SUMMARY OF THE INVENTION

Generally, in various embodiments, measured results of tasks such as advertising placement and web site optimization are used to competitively reward performance. For example, competitions may be held to the performance of the task, and the measured results used to reward winners. Defined metrics that have business impact may be used to measure performance, which may be made available to customers and potential customers, and the competitors may be rewarded commensurately with their actual, measured business impact.

In general, in one aspect, a system for competitive performance of a marketing-related tasks includes a user module for publishing performance statistics of task performers, a competition module for facilitating selection of task performers for participation in a competition, an interface server for collecting response to the task performance of each selected competitor, a performance module for updating the performance statistics for task performers based on the response; and an administration module for compensating task performers based on the published performance statistics. The task may include, for example, advertising placement and/or web site optimization. Task performers may be selected based on published performance statistics.

In some embodiments, a backoffice component determines content to show to browsers. The backoffice component may determine content provided by a web site. The backoffice component may comprise a content delivery system. The backoffice component may comprise a web server. The backoffice component may be in communication with a web server for determining content to show to browsers. A competition module may receive direction from task performers and communicate the direction to the backoffice component, thereby permitting task performers to specify content to be delivered. The backoffice component may determine and report performance statistics used to evaluate the performance of task performers. The backoffice component may reports statistics to the competition server.

In some embodiments, The backoffice component may determine advertisements that are provided by web sites, for example based on the selections of task performers. The backoffice component may include an advertising network. A purchasing component may be used for the specification and purchasing of advertising content. The purchasing component may be in communication with the backoffice component for purchasing advertisements on sites served by the backoffice component.

A campaign server may be used to allow multiple task performers to select and purchase ad placements. The campaign server can, for example, manage the allocation of ad budgets and placements. The campaign server can manage payments to an advertising network.

In general, in one aspect, the invention relates to a system and method for collecting and comparing the performance of ad placers. In one exemplary embodiment, a web-based platform is provided for collecting and publishing the performance statistics of ad placers. The web site also facilitates selection of ad placers for participation in an ad campaign based on the published performance statistics. Each of the ad placers selects advertising placements for the time period of the campaign. The response (e.g., of the viewing public) to the ads placed by each ad placer are collected, and performance statistics updated based on the response. This facilitates the identification of excellent ad placers for use in ad campaigns.

In some embodiments, the method may include conducting an ad campaign as a competition, in which one or more prizes are awarded to ad placer(s) participating in the campaign based on their performance.

In general, in one aspect, a method for web site optimization includes publishing performance statistics of optimizers, facilitating selection of optimizers for participation in a competition based on the published performance statistics, facilitating optimization by each selected competitors, collecting response to the optimization of each selected competitor, updating the published performance statistics based on the response; and compensating the optimizers based on the published performance statistics. In some embodiments, a prize is awarded to the optimizer with the best performance.

In some embodiments, in combination with the ad placement and/or web site optimization, one or more competitions are conducted for the design of advertising content to be placed or content to be optimized by competitors (e.g., ad placers and/or optimizers), for example as described in co-pending U.S. patent application Ser. No. 11/655,768, entitled SYSTEM AND METHOD FOR DESIGN DEVELOPMENT by John M. Hughes, filed Jan. 19, 2007. Design contests may be held, for example, for graphics design of advertising content, web sites, design of web sites, and so on. Submissions in such contests may be evaluated for technical merit (i.e., meeting the described requirements) and/or based on customer affinity and/or appeal to a designated group of individuals. Thus, in some embodiments, a first competition may be held for the design of advertising content and/or a web site, and a second competition may be held for the placement of the advertising content and/or optimization of the web site.

The systems and methods described can be implemented as software running on computers and other devices.

Other aspects and advantages of the invention will become apparent from the following drawings, detailed description, and claims, all of which illustrate the principles of the invention, by way of example only.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a flowchart illustrating by example an embodiment of the invention.

FIG. 2 is a flowchart illustrating by example an embodiment of the invention.

FIG. 3 is a block diagram illustrating by example an embodiment of a contest-based development process.

FIG. 4 is block diagram illustrating by example an optimization environment according to an embodiment of the invention.

FIG. 5 is block diagram illustrating by example an optimization environment according to an embodiment of the invention.

FIG. 6 is an exemplary screen display showing competitor performance in an embodiment of the invention.

FIG. 7 is an exemplary screen display showing an optimizer profile in an embodiment of the invention.

FIG. 8 is an exemplary screen display showing an ad placer profile in an embodiment of the invention.

FIG. 9 is block diagram of a system implementation according to an embodiment of the invention.

FIG. 10 is block diagram of a system implementation according to an embodiment of the invention.

### DETAILED DESCRIPTION

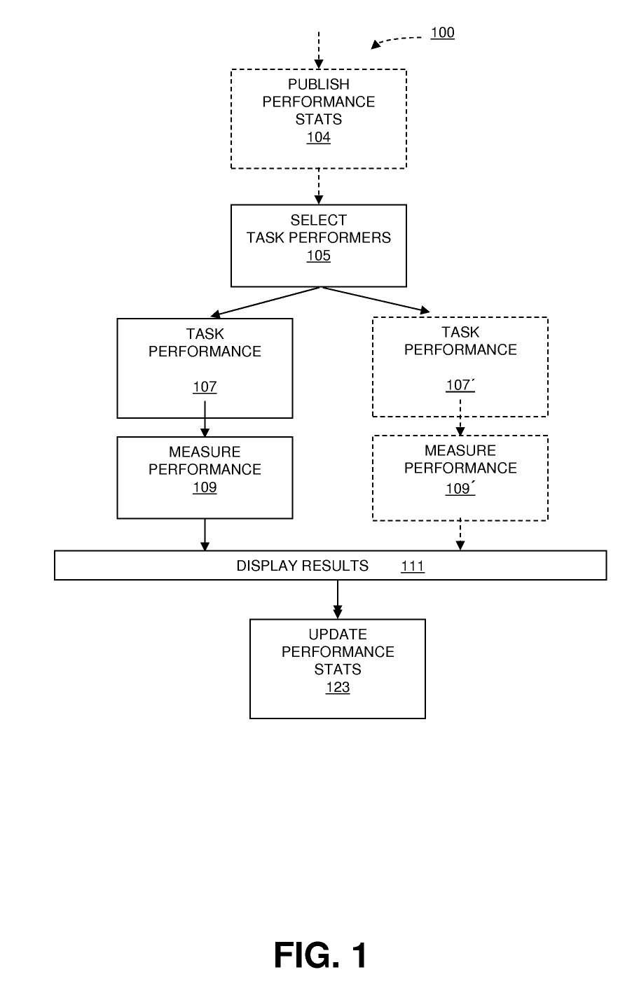

Referring to FIG. 1, in general, the invention relates to a system and method for collecting and comparing the performance of ad placers and/or web site optimization.

In one exemplary embodiment, the performance statistics of competitive task performers (e.g., ad placers and/or content optimizers) are published 104. In a preferred embodiment, the performance statistics are published on a system (e.g., a web site) that implements the described invention. There are various ways to measure the performance of on line advertising placement and/or content optimization and any, and any combination of, suitable statistics may be used. For example, the statistics may include click-through counts, page view counts, purchases by users who viewed the site and/or came from a search engine, revenue generated by advertising viewers and/or users who came from a search engine(s), etc. and in raw numbers, averages, over specific time periods, adjusted for budget, changes made, etc. Likewise, comparative statistics, such how the performance of ad placers and/or optimizers compares to the performance of other ad placers and/or optimizers in the same competitions using algorithms that take into account some or all of such factors. There may be ratings of the ad placers and/or optimizers based on performance to facilitate performance comparison and rankings of the ad placers and/or optimizers based on the ratings. One goal is that the information provided allows a customer to select ad placers and/or optimizers to participate in a competition based on their actual, measured performance, and fair comparisons to others.

The system may facilitate selection of task performers (e.g., ad placers, optimizers) 105 for participation in task performance (e.g., an ad campaign and/or optimization competition) based on the published performance statistics. For example, the system may present information about each competitor, including the published performance information. For example, in some embodiments, the system may allow a customer (e.g., an advertiser or a web site owner) to specify an advertising and/or optimization budget, and/or to request proposals from task performers. The proposals may, for example, specify the proposed changes in detail, provided an estimate of the expected response and/or provide information about the task performer's past performance in similar competitions. As another example, in some embodiments, the customer may search the information about the task performers on the site, and invite task performers to participate in a competition based on their past performance.

The customer may select one or more task performers to participate in the competition 105. Preferably, at least two task performers are selected. The task performers may be notified of their selection.

The task performers perform the task 107, 107′ in accordance with the rules of the competition. For example, in some embodiments, for web site optimization, the web site owner makes available to the optimizers a copy of the web site in question. The optimizers may conduct the optimization by making changes to the web site. The optimizer can designate the placement for pages as well.

In some embodiments, optimizers make or have made the optimization changes 107, 107′. In some embodiments, optimizers make the changes themselves. In some embodiments, budget for optimization is allocated to the optimizers, so that they can have others make the changes on their behalf. For example, an optimizer might specify changes to be made to the web site, and the optimizer may hire a developer to make the changes. In some embodiments, the optimizer holds a competition to make the changes. The budget for an individual optimizer may be determined by dividing the total competition budget by the number of optimizers selected. The budget may be determined by specifying a number of optimizers and budgeting an average amount for the types of changes likely to be requested. The budget for an individual optimizer may be determined according to proposals made by the optimizer and/or budget criteria (e.g., minimums or maximums) specified by the optimizer. In some embodiments, the optimizers may need to confirm and/or accept appointment to the competition based on the budget or otherwise.

In some embodiments, each optimizer is assigned a “mirror” set of web pages, which are all shown in parallel. In this way all pages of the site are made available to the search engines, and the performance of each of the web pages is recorded. Each of these web pages may be assigned their own URL, and in some cases their own domain name, so that search engine crawlers can find their way to each of the pages.

In some embodiments, the pages may be presented to users in a “round robin” fashion at the same URL or URLs, such that some viewers see one set of pages and other viewers see a different set of pages. With enough viewers, assessments can be made about the differences in behavior of the viewers to the different sets of pages. The pages may be distributed in as even a fashion as practical, in order to allow for a fair comparison.

In some embodiments, a set of pages may be presented for a period of time, for example, one day, two days, one week, one month, etc. and another set of pages presented for the following period of time, for example, the next day, days, week, month, etc. In this way, each set of pages has a period of time during which the pages are read by search engine crawlers, and the results reviewed. In some cases, after a change of pages, the search engines are notified of the page changes, so that their crawlers will visit the sites. Some search engines rely on links into web pages as well as the organization of the pages, and this may be harder to compare without having the pages there for some period of time.

In some cases, particularly competitions that take place over time, results may be adjusted based on holidays, overall web traffic as measured at this and other sites, and so forth, so as to try and get a fair comparison.

In some embodiments, the competition is to provide a “link plan” in addition or instead of the web site changes. For example, given the existing set of links to the site, and the site itself, the competition is to suggest changes to other web sites or other parts of a web site that will increase search engine web site traffic as measured, for example, using such criteria as discussed above. The effects may be measured over larger time periods, for example, or otherwise in a manner that allows performance to be measured.

In some embodiments, for ad placement, the ad placers are limited to “pay per click” advertisements. The advantage of such advertisements is that the advertiser only pays for actual user “clicks” on the advertisements. No allocation of advance funds are needed to purchase the advertising. The ad placers may make ad placement selections 107, 107′ to place ads within the constraints of the campaign. In some embodiments, the contest system includes access to ad placement infrastructure such that the ad placer can designate the places for the ads, while the charges for the ads are taken from the advertiser's account. It is also possible for the ad placers to specify the sites on which the ads should be placed, and the advertiser to purchase the specified advertisements directly. In any case, the selections of the ad placers are recorded so that the performance may be determined.

In some embodiments, budget for ad placement is allocated to the ad placers. The budget for an individual ad placer may be determined by dividing the total campaign budget by the number of ad placers selected. The budget may be determined by specifying allocation of a portion of the ad placement budget to each ad placer selected. The budget for an individual ad placer may be determined according to proposals made by the ad placer and/or ad placement budget criteria (e.g., minimums or maximums) specified by the ad placer. In some embodiments, the ad placers may need to confirm and/or accept appointment to the campaign based on the budget or otherwise. In some cases, the budget may be used to limit placements when the budget has been reached. In this way, selection or more expensive ads will limit the number of ads that will be shown on the ad placers behalf.

In some embodiments, ad placers make ad placement selections 107, 107′ placing the ads within the constraints of the allocated budget. In some embodiments, the ad placers may directly apply the budget to the sites on which the ads will be placed. In some embodiments, the contest system includes access to ad placement infrastructure such that the ad placer can designate places to place the ads, and the money for the ads is taken from the advertiser's account. In some embodiments, the ad placers may specify the sites on which the ads should be placed, and the advertiser purchases the specified advertisements directly. In some embodiments, the ad placers negotiate and obtain the ad placement on behalf of the client, and instructions for payment are communicated to the client.

In some embodiments, some competitions are limited to “pay per click” advertisements, and other competitions include a facility to use other types of advertising purchases. Competitions that are limited to pay per click allow ad placers to build a reputation based on performance on a level playing field, while minimizing risk on the part of the advertiser, because in the pay per click campaigns, the advertiser only pays for actual web site visitor clicks, and so there is no risk of payment without some benefit. In these competitions, depending on the advertising budget, it may be possible to allow any number of participants, or first-come, first-served, or limit participation only based on proposed strategy. Such competitions allow ad placers to become familiar with the system and to develop a performance rating.

It may be a better value, in some cases, for the advertisers for an ad placer to purchase, for example, a fixed-price ad placement at a particularly relevant web site, or to try other advertising purchasing strategies. This options that may be permitted, in some embodiments, with reduced risk by limiting campaigns that permit such options to ad placers who have proven their skill. Thus, in some cases, participation in competitions may be restricted to ad placers who have achieved rating, for example in pay-per-click competitions. The ad placers may also be required to have other qualifications instead or in addition.

It should be understood that the selection of ad placement may include (without limitation) selection of any suitable parameters, for example, web site location, date/time ranges, page specifications, key word selection, search terms, viewer demographics, viewer history, content word selection, content category selection and so on. There may be combinations of these parameters and/or additional parameters as well.

The response (e.g., of the viewing public) to the task performance (e.g., ads placed and/or optimizations made) by each task performer is measured 109. The response may be measured in any suitable manner. Just as a few examples, page views (on a site, a particular portion of a site, on a particular page, etc.), click-throughs (clicks on a particular link, links, etc.), inquiries, telephone calls, demographic data, purchase data, revenue data, and so on may be used to measure performance of the ad placement and/or optimization. In many cases, the ultimate result, such as purchases from users who came from a particular web site and/or pages, and/or who used a particular search criteria or a particular ad or link that is found on a site, may be used.

For example, some online advertisements allow for tracking of visitors that come from a advertisement or site to a particular page. If a search engine is used, the search engine may be identified, and this information may be used to determine the effectiveness of a optimization to bringing visitors to a site, particularly visitors who are interested in certain types of activity (e.g., purchasing). Once at a destination site, the activity of these site visitors may be followed to determine, for example, whether they purchase products, or download videos, etc. In many cases, it is preferable to attract visitors that will purchase or take other desired actions on the site. In such case, the performance metrics will help determine whether the “right” type of visitors are being invited to and/or directed within the site and/or to the desired content and/or activity.

The results of the measurements may be displayed 111 and the overall performance statistics of the task performers may be updated 123. This information may be used by these and other customers to select task performers in future competitions. This facilitates the identification of excellent task performers, for example, for use in advertising content, web site development and/or optimization competitions.

In various embodiments, the task performers may be compensated in various ways. Just to give some examples, the task performers may be paid a fixed fee to participate in the competition, the task performers may be paid an amount proportional to their portion of the competition budget, the task performers may be paid an amount that varies based on their performance data and/or statistics, and/or the task performers may be paid based on their performance as compared to other task performers. In some embodiments, one or more prizes are provided for the task performers with excellent performance in the competition. In some embodiments, one or more prizes are provided for task performers with excellent performance in different types of tasks (e.g., advertising performance, web site optimization) within the same competition. In some embodiments, a competition is held for the performance of a task or tasks (e.g., placement of advertisements and/or web site optimization), and the winner(s) are the task performers with the best performance as measured in that competition.

In some embodiments, task performers are rewarded based on their performance as aggregated over multiple competitions. For example, a “bonus” or other incentive may be given to an task performer with the highest performance over a particular period. In some embodiments, “points” may be awarded for participation and/or performance in each competition over a period of time. In such cases, additional money may be awarded to task performers who consistently do well, but do not win, in a number of competitions. This may provide incentive for continued participation.

In some embodiments, each competition has an assigned point value. The point value may be, for example, related to the size of the competition. Depending on the number of task performers participating in the competition, the points may be divided according to TABLE 1. Bonus payments will be made at predetermined periods to task performers with the most points. For example, an task performer with the highest points may receive the highest prize. In some embodiments, the amount of the prize is in proportion to the number of points won, so that task performer who has won 15% of the total points during the period wins 15% of the pool. This has the effect of creating larger pools for the consistent winners, and also giving some amount to task performers who participate on an ongoing basis.

TABLE 1
Percentage of Placement Points

| | # of task performers in competition | | | | |
|---|---|---|---|---|---|
| Place | 1 | 2 | 3 | 4 | 5 |
| 1^{st} | 100% | 70% | 65% | 60% | 56% |
| 2^{nd} | | 30% | 25% | 22% | 20% |
| 3^{rd} | | | 10% | 10% | 10% |
| 4^{th} | | | | 8% | 8% |
| 5^{th} | | | | | 6% |

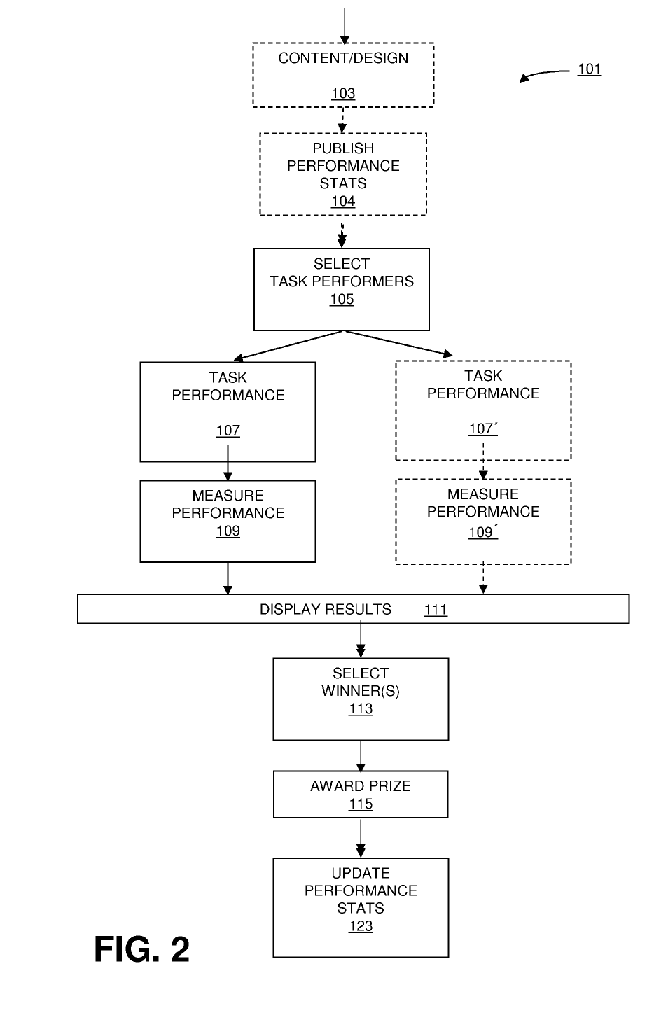

Referring to FIG. 2, in some embodiments, competition (e.g., ad campaign, optimization competition) takes place in the context of a series of one or more competitions for the performance of that type of task or tasks.

In the context of the competition, web site design and/or content is developed and/or advertising content is provided 103. This may be accomplished by using already-existing content and/or designing new or updated content. This may be accomplished by conducting competitions for the development of content. In some cases, task performers may have some or all of the responsibility for developing the content that they will use. In some cases, the task performers may advise and/or comment on and/or request changes to the content that is available, and indicate whether they think it is appropriate, suggest layouts, formatting, metadata, and so forth.

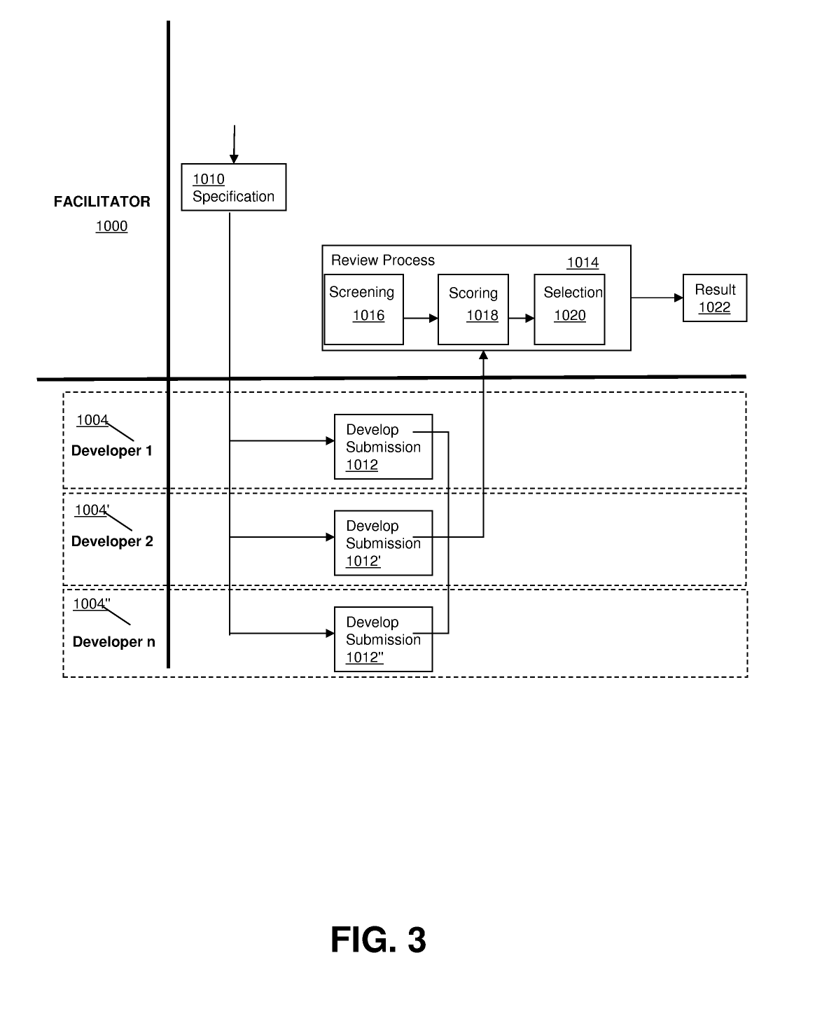

There may be, for example, one or more design competitions for the creation of advertising and/or web site design and/or other content (e.g., logos, graphics, web pages, storyboards, etc.), for example as described further below with reference to FIG. 3. Such a competition may be held by the customer (e.g., advertiser, web site owner), and the customer may in some cases have the help and/or advice and/or assistance of one or more task performers. In some cases, task performers that are participating in the competition may be allocated a budget to hold one or more competitions to develop content and/or changes to content. In some cases, the task performers may participate in the specification of competition requirements for the development of advertising content. Just as one example, there may be a competition for the development of graphics that will go on a web site or as part of advertising, content to go on the web site or as part of advertising, designs to go on the web site or as part of advertising, and so forth. This content may be organized and placed by task performers, and the task performers may have the opportunity to comment on the requirements for the content that will be developed. As another example, for an optimization competition, there may be a competition for development of web site content elements, and the task performers each may be allowed to select site elements that they will use in their part of the optimization competition. As another example, for an advertising placement competition there may be a competition for development of banner advertisements, and the ad placers each may be allowed to select one or banner advertisements as a competition winner that they will use in their part of their competitive advertising campaign. In some embodiments, the competition for the development of content 103 may be optional or not included.

As described above (with reference to FIG. 1), performance statistics about the task performers may be published 104 and made available to the customers. In some cases, other information about the task performers, such as their desire to participate in particular competitions or types of competitions, etc. also may be available to the customers. The customers may specify a competition prize or prizes for the best performance in the competition, as well as the criteria to be used to judge the competitors. In various embodiments, the customers invite task performers or specify criteria for task performers who will be permitted to participate, and the task performers are selected 105 and committed to the competition. The task performers then perform the tasks as part of the competition 107, their performance is measured 109, and the results displayed 111.

In preferred embodiments, the task performer(s) with the best performance is/are designated as the winner(s) 113, and prize(s) awarded. There may be only one prize, or there may be a first place, second place, etc. In some cases, a prize pool may be divided based on the placement of the task performers. For example, first place might receive $10,000, second place $3,000, and third place $1,000 in a competition with three task performers. In some cases, the prize pool may be related to the revenue generated by the competition (e.g., the total prize pool is 10% of the revenue generated by the advertising). In some cases the allocation prize pool may be determined by the performance statistics, for example such that the task performer responsible for 50% of the revenue receives 50% of the prize pool, the task performer responsible for 30% of the revenue receives 30% of the prize pool, and four other task performers, each responsible for 5% of the revenue, each receive their respective share of 5% of the prize pool.

In any case, the task performer's performance statistics may be updated 123, to facilitate their qualification and/or selection in future competitions.

Referring to FIG. 3, in one embodiment, one possible generalized implementation of a contest for the development of an asset is shown. The asset may be any sort or type of asset that may be developed by an individual or group. As non-limiting illustrative examples, an asset may be a graphic design, a web page control, an active display object, a banner ad, a text ad, a square ad, marketing content, informational content, graphic interface, and so on. Thus, these types of competitions are one way to develop web site content 103 (FIG. 2) as described above.

As further non-limiting illustrative examples, an asset may be a software program, logo, graphic design, specification, requirements document, wireframe, static prototype, working prototype, architecture design, component design, implemented component, assembled or partially-assembled application, testing plan, documentation, language translation, and so on.

In some embodiments, the development process is monitored and managed by a facilitator 1000. The facilitator 1000 can be any individual, group, or entity capable of performing the functions described here. The facilitator 1000 may be an administrator. In some cases, the facilitator 1000 can be selected from a the distributed community of contestants based on, for example, achieving exemplary scores on previous submissions, or achieving a high ranking in a competition. In other cases, the facilitator 1000 may be appointed or supplied by an entity requesting the development, and thus the entity requesting the competition oversees the competition.

The facilitator 1000 has a specification 1010 for an asset to be developed by competition. In general, a specification 1010 is intended to have sufficient information to allow contestants to generate the desired asset. In some cases, the specification 1010 may include a short list of requirements. In some cases the specification may include the result of a previous competition, such as a design, wireframe, prototype, and so forth. In some cases, the specification may be the result of a previous competition along with a description of requested changes or additions to the asset. The facilitator 1000 may review the specification 1010, and format or otherwise modify it to conform to standards and/or to a development methodology. The facilitator 1000 may in some cases reject the specification for failure to meet designate standards. The facilitator 1000 may mandate that another competition should take place to change the specification 1010 so that it can be used in this competition. The facilitator 1000 may itself interact with the entity requesting the competition for further detail or information.

The facilitator 1000 may specify rules for the competition. The rules may include the start and end time of the competition, and the awards(s) to be offered to the winner(s) of the competition, and the criteria for judging the competition. There may be prerequisites for registration for participation in the competition. Such prerequisites may include minimum qualifications, rating, ranking, completed documentation, legal status, residency, location, and others. In some cases, the specification may be assigned a difficulty level, or a similar indication of how difficult the facilitator, entity, or other evaluator of the specification, believes it will be to produce the asset according to the specification. Some of the specification may be generated automatically based on the type of competition.

The specification is distributed to one or more developers 1004, 1004′, 1004″ (generally, 1004), who may be members, for example, of a distributed community of asset developers. In one non-limiting example, the developers 1004 are unrelated to each other. For example, the developers may have no common employer, may be geographically dispersed throughout the world, and in some cases have not previously interacted with each other. As members of a community, however, the developers 1004 may have participated in one or more competitions, and/or have had previously submitted assets subject to reviews. This approach opens the competition to a large pool of qualified developers. As another example, the developers may be employed by or have a relationship with a particular entity.

The communication can occur over a communications network using such media as email, instant message, text message, mobile telephone call, a posting on a web page accessible by a web browser, through a news group, facsimile, or any other suitable communication. In some embodiments, the communication of the specification may include or be accompanied by an indication of the rules including without limitation the prize, payment, or other recognition that is available to the contestants that submit specified assets. In some cases, the amount and/or type of payment may change over time, or as the number of participants increases or decreases, or both. In some cases submitters may be rewarded with different amounts, for example a larger reward for the best submission, and a smaller reward for second place. The number of contestants receiving an award can be based on, for example, the number of contestants participating in the competition and/or other criteria. Rewards may be provided for ongoing participation in multiple competitions, for example as described in co-pending U.S. patent application Ser. No. 11/410,513 to Hughes et al., filed May 1, 2006, entitled System and Method for Compensating Contestants.

The recipients 1004 of the specification can be selected in various ways. In some embodiments all members of the community have access via a web site. In some embodiments, member may register for a contest to gain access. In some embodiments, members of the community may have expressed interest in participating in a particular type of development competition, whereas in some cases individuals are selected based on previous performances in competitions, prior projects, and/or based on other methods of measuring programming skill of a software developer. For example, the members of the community may have been rated according to their performance in a previous competition and the ratings may be used to determine which programmers are eligible to receive notification of a new specification or respond to a notification. The community members may have taken other steps to qualify for particular competitions, for example, executed documentation such as a non-disclosure agreement, provided evidence of citizenship, submitted to a background check, and so forth. Recipients may need to register for a competition in order to gain access.

In one embodiment, a facilitator 1000 moderates a collaborative discussion forum among the various participants to answer questions and/or to facilitate development by the contestants. The collaborative forum can include such participants as facilitators, developers, customers, prospective customers, and/or others interested in the development of certain assets. In one embodiment, the collaboration forum is an online forum where participants can post ideas, questions, suggestions, or other information. In some embodiments, only a subset of the members can post to the forum, for example, participants in a particular competition or on a particular team.

Upon receipt of the specification 1010, one or more of the developers 1004 each develop assets to submit (shown as 1012, 1012′ and 1012″) in accordance with the specification 1010. The development of the asset can be done using any suitable development system, depending, for example, on the contest rules and requirements, the type of asset, and the facilities provided. For example, there may be specified tools and/or formats that should be used.

Once a developer 1004 is satisfied that her asset meets the specified requirements, she submits her submission, for example via a communications server, email, upload, facsimile, mail, or other suitable method.

To determine which asset will be used as the winning asset as a result of the contest, a review process 1014 may be used. A review can take place in any number of ways. In some cases, the facilitator 1000 can engage one or more members of the community and/or the facilitator and/or the entity requesting the asset. In some embodiments, the review process includes one or more developers acting as a review board to review submissions from the developers 1004. A review board preferably has a small number of (e.g., less than ten) members, for example, three members, but can be any number. Generally, the review board is formed for only one or a small number of related contests, for example three contests. Review boards, in some embodiments, could be formed for an extended time, but changes in staffing also can help maintain quality. In some embodiments, where unbiased peer review is useful, the review board members are unrelated (other than their membership in the community), and conduct their reviews independently. In some embodiments, reviewers do not know the identity of the submitter at the time that the review is conducted.

In some embodiments, one member of the review board member is selected as a primary review board member. In some cases, a facilitator 1000 acts as the primary review board member. The primary review board member may be responsible for coordination and management of the activities of the board.

In some embodiments, a screener, who may be a primary review board member, a facilitator, or someone else, screens 1016 the submissions before they are reviewed by the (other) members of the review board. In some embodiments, the screening process includes scoring the submissions based on the degree to which they meet formal requirements outlined in the specification (e.g., format and elements submitted). In some embodiments, scores are documented using a scorecard, which may be a document, spreadsheet, online form, database, or other documentation. The screener may, for example, verify that the identities of the developers 1004 cannot be discerned from their submissions, to maintain the anonymity of the developers 1004 during review. A screening review 1016 may determine whether the required elements of the submission are included (e.g., all required files are present, and the proper headings in specified documents). The screening review can also determine that these elements appear complete.

In some embodiments, the screening 1016 includes initial selection by the entity that requested the competition. For example, if the competition is for a wireframe, the entity may select the wireframes that seem to be the best. This smaller group may then go on to the next step.

In some embodiments, the screener indicates that one or more submissions have passed the initial screening process and the reviewers are notified. The reviewers then evaluate the submissions in greater detail. In preferred embodiments, the review board scores the submissions 1018 according to the rules of the competition, documenting the scores using a scorecard. The scorecard can be any form, including a document, spreadsheet, online form, database, or other electronic document. There may be any number of scorecards used by the reviewers, depending on the asset and the manner in which it is to be reviewed.

In some embodiments, the scores and reviews from the review board are aggregated into a final review and score. In some embodiments, the aggregation can include compiling information contained in one or more documents. Such aggregation can be performed by a review board member, or in one exemplary embodiment, the aggregation is performed using a computer-based aggregation system. In some embodiments, the facilitator 1000 or a designated review board member resolves discrepancies or disagreements among the members of the review board.

In one embodiment, the submission with the highest combined score is selected as the winning asset 1020. The winning asset may be used for implementation, production, or for review and input and/or specification for another competition. A prize, payment and/or recognition is given to the winning developer.

In some embodiments, in addition to reviewing the submissions, the review board may identify useful modifications to the submission that should be included in the asset prior to final completion. The review board documents the additional changes, and communicates this information to the developer 1004 who submitted the asset. In one embodiment, the primary review board member aggregates the comments from the review board. The developer 1004 can update the asset and resubmit it for review by the review board. This process can repeat until the primary review board member believes the submission has met all the necessary requirements. In some embodiments, the review board may withhold payment of the prize until all requested changes are complete.

In some embodiments, a portion of the payment to the developer 1004 is withheld until the until after other competitions that make use of the asset are complete. If any problems with the asset are identified in the further competitions, these are provided to the reviewer(s) and the developer 1004, so that the requested can be made by the developer 1004.

There also may be prizes, payments, and/or recognition for the developers of the other submissions. For example, the developers that submit the second and/or third best submissions may also receive payment, which in some cases may be less than that of the winning contestant. Payments may also be made for creative use of technology, submitting a unique feature, or other such submissions. In some embodiments, the software developers can contest the score assigned to their submission.

It should be understood that the development contest model may be applied to different portions of work that are required for the development of an overall asset. A series of development contests is particularly suitable for assets in which the development may be divided into stages or portions. It can be beneficial in many cases to size the assets developed in a single competition such that work may be completed in several hours or a few days. The less work required to develop a submission, the lower the risk for the contestants that they will not win, and increased participation may result.

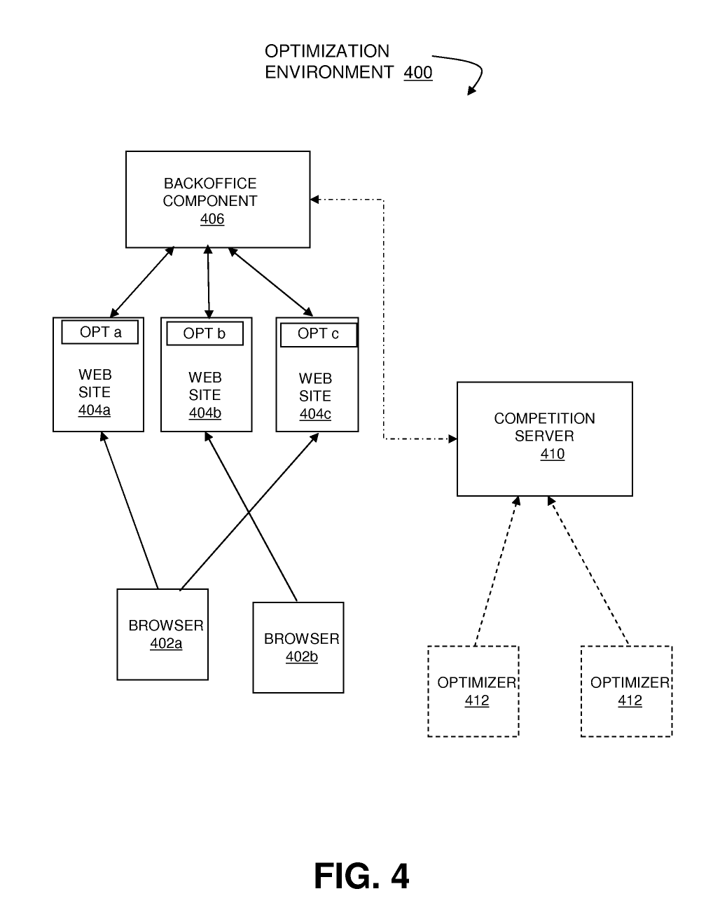

Referring to FIG. 4, in a simplified, demonstrative, exemplary embodiment of an optimization environment 400, web site visitors using web browsers 402a, 402b (generally, 402) visit web sites 404a, 404b, 404c (generally, 404). Each of these web sites 404 have content that are provided by a backoffice component 406. It should be understood that this is a simplified example, and that there may be any number of browsers, web sites, backoffice components, etc.

The backoffice component 406, based on the selections of the optimizers, determines the content that is provided by the web sites 404. In some embodiments, the backoffice component includes a content delivery system. In some embodiments, the backoffice component is part of the web sites 404. In some embodiments, the web site owner and/or an optimizer has a relationship directly with the owner of the backoffice component 406, and in other cases indirect arrangements are made.

In some embodiments, the backoffice component 406 makes a determination about the content to show to the browsers 402 based on the activities of the browser, the address and/or content of the web pages, and/or a variety of other factors. For example, the backoffice component 406 may make a determination about which web site to display based on the referring site of the visitor, the key words searched by the visitor, the URL requested by the browser, and so on.

In some embodiments, the backoffice component 406 may be accessed by a competition server 410. The competition server allows for multiple optimizers to interact with the competition server to created an optimized web site.

The backoffice component 406 may be used, for example, to determine and report some of the statistics that may be used to evaluate the performance of the competition. The statistics may be reported directly to the competition server 410, or another suitable communication method may be used.

Optimizers 412 may interact with the competition server as described herein in order to create optimized web sites for web site owners. The optimizers 412 also may use the competition server to register for and/or participate in competitions, to provide information about themselves, their qualifications, their performance, and their interests to web site owners.

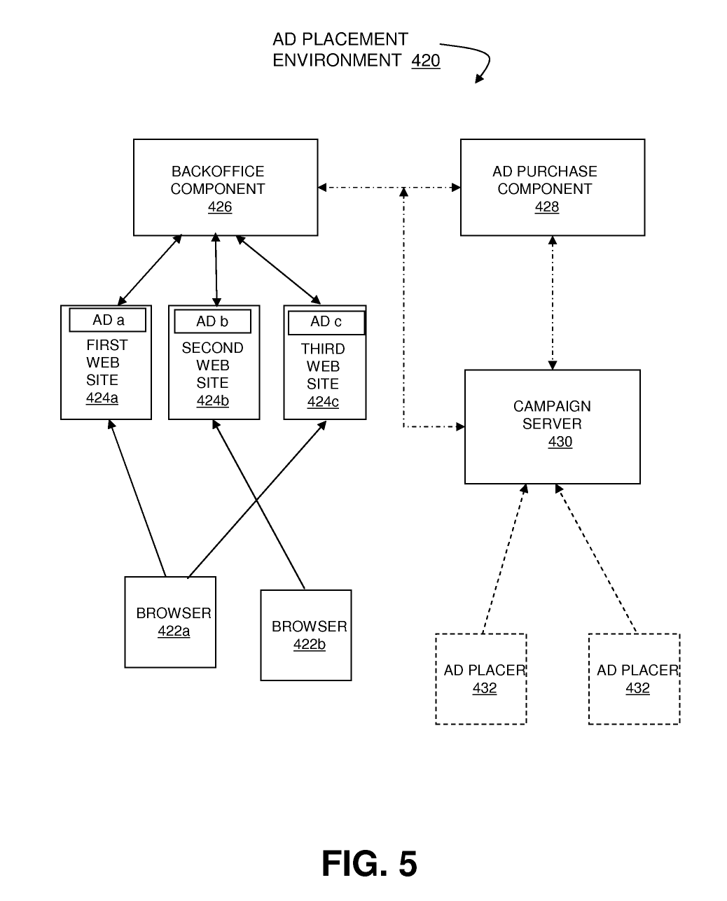

Referring to FIG. 5, in a simplified, demonstrative, exemplary embodiment of an ad placement environment 420, web site visitors using web browsers 422a, 422b (generally, 422) visit web sites 424a, 424b, 424c (generally, 424). Each of these web sites 424 have advertisements that are provided by a backoffice component 426. It should be understood that this is a simplified example, and that there may be any number of browsers, web sites, backoffice components, etc.

The backoffice component 426, based on the selections of ad placers, determines the advertisements that are provided by the web sites 424. In some embodiments, the backoffice component is a service of an advertising network. In some embodiments, the backoffice component is owned by or part of the web sites 424. In some embodiments, the advertiser and/or an ad placer has a relationship directly with the owner of the backoffice component 426, and in other cases indirect arrangements are made.

In some embodiments, the backoffice component 426 makes a determination about the advertisement to show to the browsers 422 based on the activities of the browser, the address and/or content of the web pages, and/or a variety of other factors. Typically, the backoffice component 426 interacts with a purchasing component 428, which allows for the purchase of advertisements on the sites served by the backoffice component(s) 426. The purchasing component 428 allows for the specification and purchasing of advertising content.

In some embodiments, the purchasing component 428 may be accessed by a campaign server 430. The campaign server allows for multiple ad placers to interact with the campaign server to select and purchase ad placements. In a preferred embodiment, the campaign server 430 interacts with multiple purchasing components 428 for various web sites, allowing the ad placers 432 who interact with the campaign server 430 to have access to many different web sites and ad networks. The campaign server can manage the allocation of the ad budgets and placements by the ad placers 432, and communicate the information as necessary, and facilitate payments to the advertising networks.

The backoffice component 426 may be part of or separate from the web servers that are serving the web sites 424. The backoffice component 426 may be used, for example, to determine and report some of the statistics that may be used to evaluate the performance of the campaign. The statistics may be reported to the purchasing component 428 and then retrieved by the campaign server, may be communicated directly to the campaign server, or another suitable method may be used.

Ad placers 432 may interact with the campaign server as described herein in order to select and purchase advertising placements for advertisers. The ad placers 432 also may use the campaign server to register for and/or participate in campaigns, to provide information about themselves, their qualifications, their performance, and their interests to advertisers.

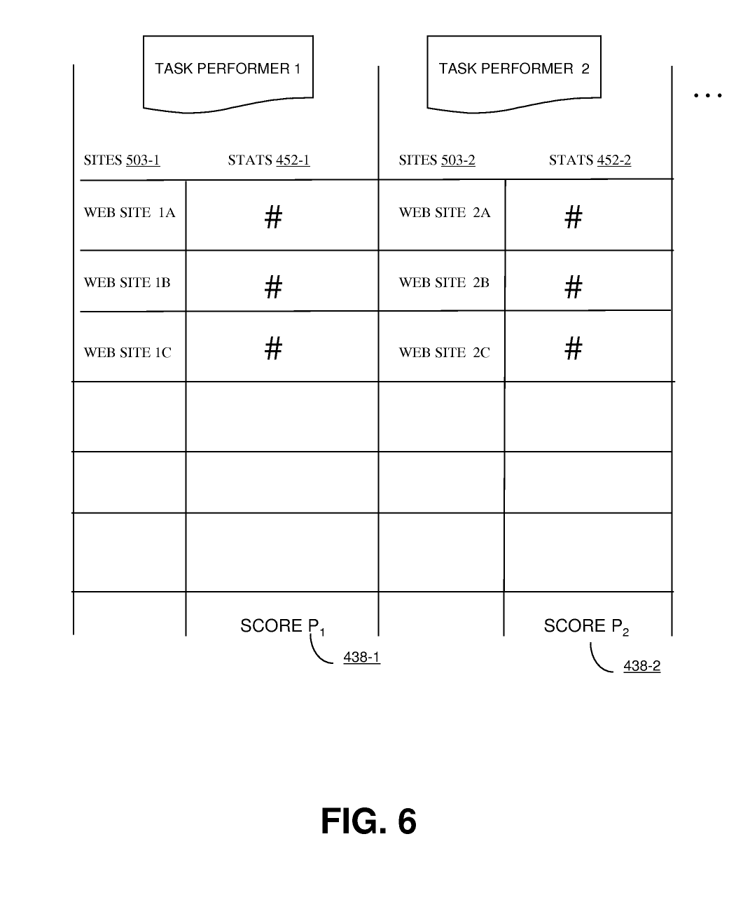

Referring to FIG. 6, a simplified, exemplary and demonstrative example of a competition scorecard is shown, which may be used to compare the performance of two hypothetical task performers, TASK PERFORMER 1 and TASK PERFORMER 2. Each of the task performers has selected sites for ad placements and/or optimization, listed in the SITES column 503-1, 503-2. For example, TASK PERFORMER 1 has sites 1A, 1B, and 1C; while TASK PERFORMER 2 has sites 2A, 2B, and 2C. It should be understood that there may be any number of web sites, and that each site, such as site 2A may be one or more pages, sites or networks, and may designate advertising parameters and/or optimize the web site in any manner, for that site, as called for in the description of the tasks to be performed, for example, metadata, html, graphic design, links, content writing, content words, specific pages or types of pages, locations for content display, and so on. Just as one example, Web Site 1A may be a specified portion of a site at a particular time of day, and Web Site 1B may be the same portion of the same site at a different time, and Web Site 1C may be a different portion of the site at a different time.

Statistics, represented by “#” are shown for each site. The statistics show the results of the task performance during the competition. The statistics may be measured by the backoffice component 406 (FIG. 4) as described above at the time of serving the advertisements. The statistics may be determined by the web sites 404, or may be determined in another manner. In some embodiments, the side-by-side comparison of actual performance of the advertising placement, web site content, web site optimization allows for the implementation of advertising and/or web site changes based on useful data.

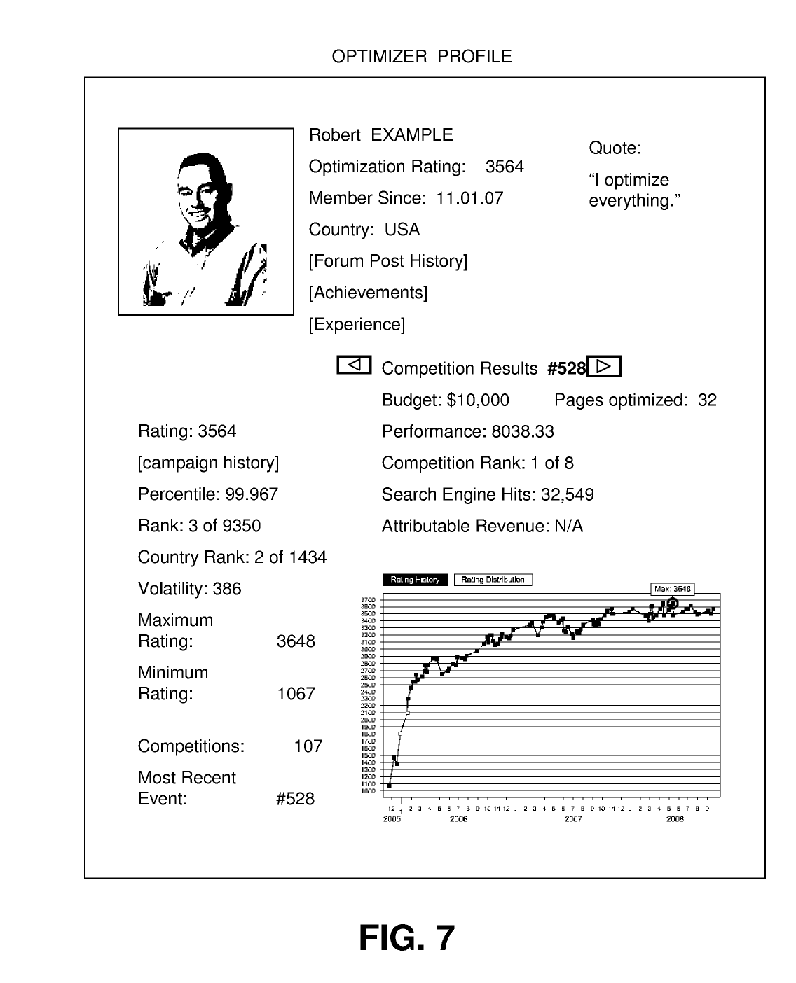

Referring to FIG. 7, a demonstrative, exemplary web site display shows information about task performer, in this example, an optimizer. The display is useful for other community members, such as optimizers and customers (e.g., web site owners) to learn about the optimizers.

The exemplary display includes the name and photo of the optimizer (in this display, “Robert Example”). In some cases, the optimizer may have a username or nickname instead or in addition to the optimizer's actual name. The display includes an overall rating for the optimizer, which in this case 3564. The date that this optimizer joined the community (Nov. 1, 2007) and the optimizer's country (USA). In some cases, the country may be the residence of the optimizer, and in other cases the optimizer may specify an affiliation country. The optimizer may be allowed to specify a quote (e.g., “I optimize everything”) and/or other selected information.

In this display, there are links provided to the optimizer's “Forum Post History,” to see instances in which the optimizer has written in community discussions. Also provided in the display is information about this optimizer's “achievements” and “experience” that may be provided by the site and/or the optimizer. Additional data about specific competitions also may be available. For example, a list of the competitions in which the optimizer participated (“competition history”), the percentile of the optimizer as compared to the community (in this display, 99.967%), and a rank (in this example, 3 out of 9350 active optimizers). As compared to other optimizers from his country, this optimizer's rank is 2 of 1434. The volatility (386) may be calculated as part of rating calculations, for example as an indicator of how much this optimizer's rating fluctuates in each event (e.g., competition). The optimizer's minimum rating (1067) and maximum rating (3648) also are shown for comparison. The number of competitions (107) and the most recent event (competition #528) are also indicated.

A graph shows the competitions in which this optimizer participated, along with the optimizer's rating as a result of each competition, with each competition designated as a point on the graph. Clicking on a competition in the graph will bring up additional detail on the results for that competition.

In this display, a “Competition Results” section provides results specifics for a particular competition. In this case, for competition #528, the competition budget allocated to the optimizer was $10,000, the number of pages optimized by the optimizer was 32, the performance measurement was 8038.33. Performance may be measured in a variety of ways, and in this example the performance measurement is specified in each competition. The competition rank indicates that this optimizer placed 1^{st} out of 8 optimizers who participated in this competition. The number of hits from search engines were in this example 32,549, and attributable revenue, which may be measured, but was not in this competition, is shown as N/A. Arrow buttons allow for navigation within the graph, to see the results of the next or previous competition in which this optimizer participated. It should be understood that the data provided in this example is demonstrative, and any other suitable statistics or data may be provided, instead and/or in addition to some or all of the data shown.

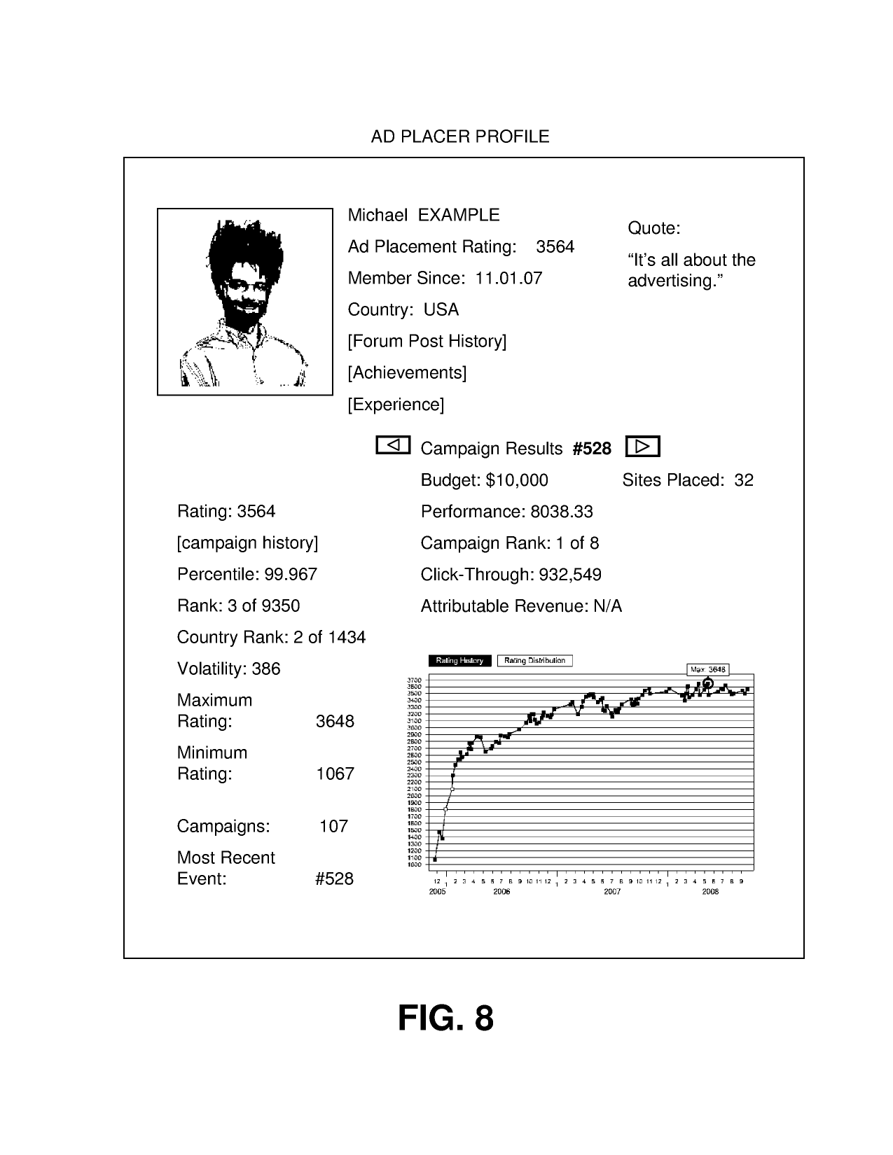

Referring to FIG. 8, a profile for an ad placer is shown. The exemplary display includes the name and photo of the ad placer (in this display, “Michael Example”). In this display, a “Campaign Results” section provides results specifics for a particular competition. In this case, for ad campaign #528, the campaign budget allocated to the ad placer was $10,000, the number of sites placed by the ad placer was 32, the performance measurement was 8038.33. Performance may be measured in a variety of ways, and in this example the performance measurement is specified in each campaign. The campaign rank indicates that this ad placer placed 1^{st} out of 8 ad placers who participated in this campaign. The number of click-through hits were in this example 932,549, and attributable revenue, which may be measured, but was not in this campaign, is shown as N/A.

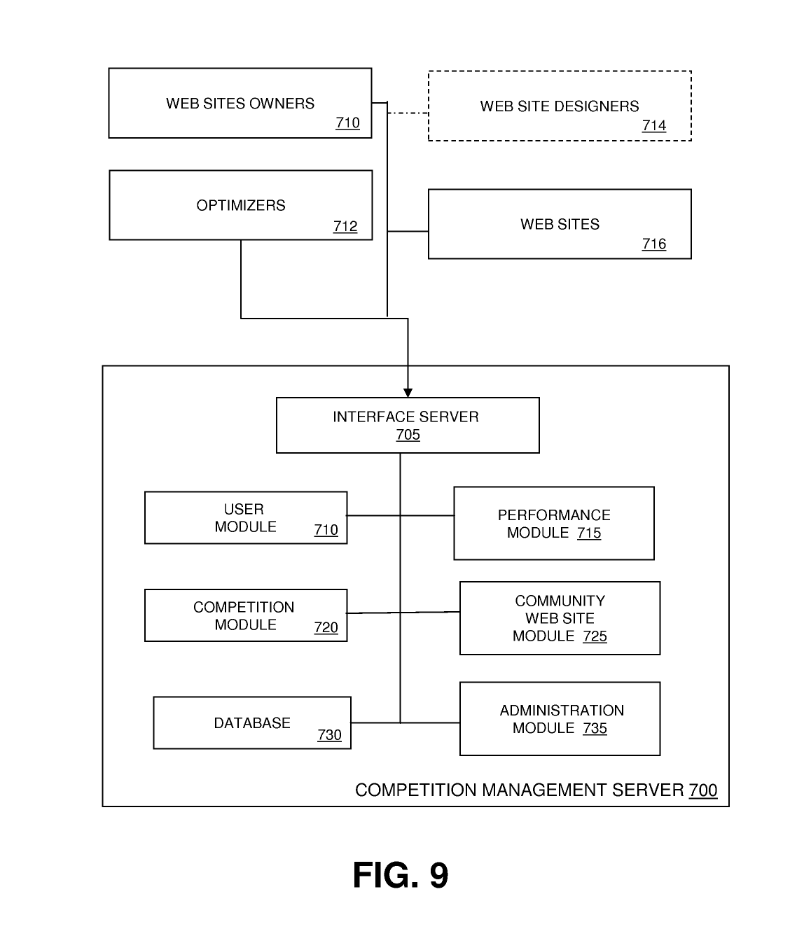

Referring to FIG. 9, a competition management server 700 includes an interface server 705 for communicating with computers operated by the competition system participants. The interface server 705 in a preferred embodiment includes a web server and such additional software as needed to communicate with the other modules. For example, an enterprise class web server, such as APACHE from the APACHE FOUNDATION, or INTERNET INFORMATION SERVER from MICROSOFT CORPORATION, may be used.

Participants include web site owners 710 who will request and finance competitions, and optimizers, who participate in the competitions. Web site designers 714, such as graphic designers, artists, flash and HTML developers, also may participate. Participating web sites 716 also may send/receive information via the interface server 705. In a preferred embodiment, the participants use web browsers to communicate with the competition management server. The participants typically have authentication information (e.g., username, password, authentication code) that they use to gain access to the competition management server via the interface server.

The competition management server 700 may include a user module 710 that tracks information associated with each user, including, in some cases, for example, the information discussed with respect optimizers in FIG. 7. The user module 710 may include, for example, web site owner information, such as competitions sponsored, results obtained, amounts paid, and so on.

The competition management server 700 may include a performance module 715 for determining performance of the optimizers during and after the competitions, and calculating ratings and rankings of the optimizers. The performance module 715 may obtain information from participating web sites 716 regarding performance from the competition module 720, which may be communicated via the interface server 705 or in some cases by contacting the participating web sites 716 directly.

The competition management server 700 may include a competition module 720 that may be used to manage competitions. For example, the competition module 720 may allow optimizers to specify optimizations and/or submit optimized web sites. The competition module 720 may communicate ad placement selections to web sites and to the other modules of the system as appropriate. The competition module 720 may provide aggregated information regarding the competition to web site owners.

The competition management server 700 may include a community web site module 725 that include such features as forums, blogs, profiles (e.g., as described with reference to FIG. 7), news, and so on. The community web site module 725 may provide such data and information about the community as may be desired.

The competition management server 700 may include a database 730 for storing data used and generated by the other modules. For example, user data created by the user module 710, performance data created by the performance module 715, competition data used by the competition module 720, forum posts and web site content created by the community web site module 725, and so on. Data can, in some instances, be stored in one or more databases. A database can also store data relating the use and performance of servers, such as server availability and web traffic information. Examples of database applications that can be used to implement the database 730 include MySQL Database Server by MySQL AB of Uppsala, Sweden, the PostgreSQL Database Server by the PostgreSQL Global Development Group of Berkeley, Calif., and the ORACLE Database Server offered by ORACLE Corp. of Redwood Shores, Calif.

The competition management server 700 may include a competition administration module 735. The administration module 735 may be used for the various administration processes. For example, in some embodiments, the administration module 735 may be used for granting user privileges, launching competition requested by web site owners, confirming awards and/or payments to optimizers, and so on. In some cases, some of these activities also may be initiated by various modules upon user request.

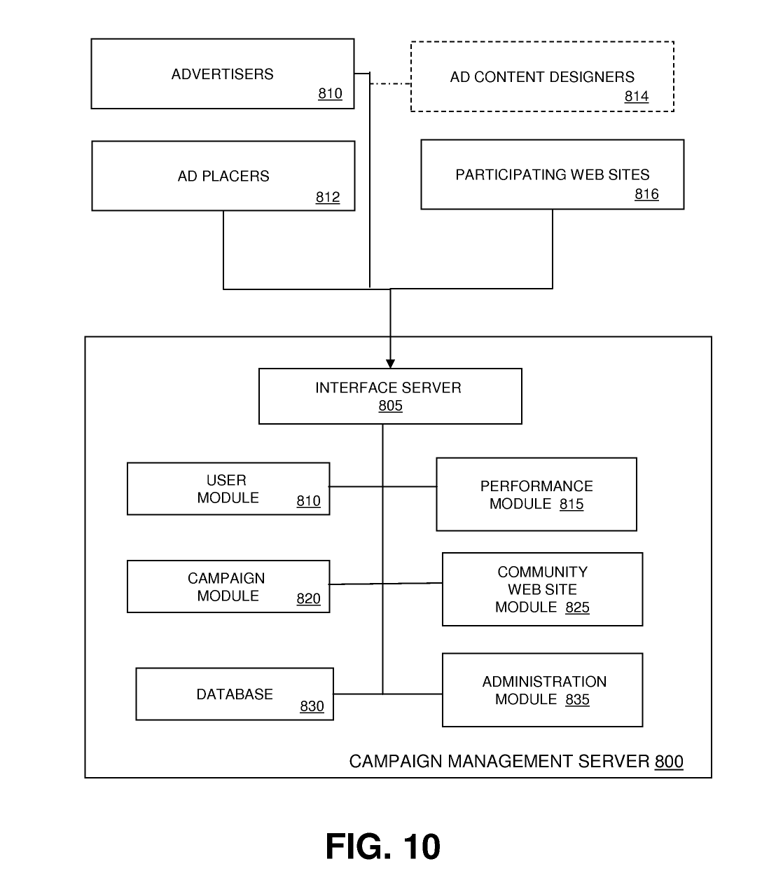

Referring to FIG. 10, a campaign management server 800 includes an interface server 805 for communicating with computers operated by the campaign system participants. The interface server 805 in a preferred embodiment includes a web server and such additional software as needed to communicate with the other modules.

Participants include advertisers 810 who will request and finance campaigns, and ad placers, who participate in the campaigns. Ad content designers 814, such as graphic designers, artists, flash and HTML developers, also may participate. Administrators of participating web sites 816 also may participate. In a preferred embodiment, the participants use web browsers to communicate with the campaign management server. The participants typically have authentication information (e.g., username, password, authentication code) that they use to gain access to the campaign management server via the interface server.

The campaign management server 800 may include a user module 810 that tracks information associated with each user, including, in some cases, for example, the information discussed with respect to ad placers in FIG. 8. The user module 810 may include, for example, advertiser information, such as campaigns sponsored, results obtained, amounts paid, and so on.

The campaign management server 800 may include a performance module 815 for determining performance of the ad placers during and after the campaigns, and calculating ratings and rankings of the ad placers. The performance module 815 may obtain information from participating web sites 816 regarding performance from the campaign module 820, which may be communicated via the interface server 805 or in some cases by contacting the participating web sites 816 directly.

The campaign management server 800 may include a campaign module 820 that may be used to manage campaigns. For example, the campaign module 820 may allow ad placers to specify ad placements. The campaign module 820 may communicate ad placement selections to web sites and to the other modules of the system as appropriate. The campaign module 820 may provide aggregated information regarding the campaign to advertisers.

The campaign management server 800 may include a community web site module 825 that include such features as forums, blogs, profiles (e.g., as described with reference to FIG. 8), news, and so on. The community web site module 825 may provide such data and information about the community as may be desired.

The campaign management server 800 may include a database 830 for storing data used and generated by the other modules. For example, user data created by the user module 810, performance data created by the performance module 815, campaign data used by the campaign module 820, forum posts and web site content created by the community web site module 825, and so on.

The campaign management server 800 may include a competition administration module 835. The administration module 835 may be used for the various administration processes as needed. For example, in some embodiments, the administration module 835 may be used for granting user privileges, launching campaign requested by advertisers, confirming awards and/or payments to ad placers, and so on. In some cases, some of these activities also may be initiated by various modules upon user request.

It should be understood that each of the modules described may be developed in software and/or hardware implementation. In a preferred embodiment, each module is a software module configured to run on a server-class computer system, with multiple processors, storage, application servers, and so on.

Ratings

In some embodiments, ratings are kept for each of the task performers, so that members of the community can see where they stand with respect to each other. In some embodiments, the rating system that is used is as follows.

The statistics of Rating, Volatility, and Number of times previously rated are kept about each task performer. Before participating in a competition, new task performer's ratings are provisional. After a competition, the algorithm below is applied to the task performers participating in the competition.

First, the ratings of task performers who have previously competed are calculated, with new task performers' performances not considered. Second, new task performers are given a rating based on their performance relative to everyone in the competition. In some cases, task performers may be assigned a “color” based on their rating, where red is for 2200+, yellow is for 1500-2199, blue is for 1200-1499, green is for 900-1199, and grey is for 0-899.

After each competition, each task performer who participated in the competition is re-rated according to the following algorithm. The average rating of everyone in the competition is calculated:

$$AveRating = \frac{{\sum }_{i = 1}^{NumCoders} {Rating}_{i}}{NumCoders}$$

Where NumCoders is the number of task performers in the competition and Rating is the rating without the volatility of the task performer in the competition before the competition.

The competition factor is calculated:

$$CF = \sqrt{\frac{{\sum }_{i = 1}^{NumCoders} {Volatility}^{2}}{NumCoders} + \frac{{\sum }_{i = 1}^{Numcoders} {( {Rating}_{i} - AveRating )}^{2}}{NumCoders - 1}}$$

Where Volatility is the volatility of the task performer in the competition before the competition.

The Win Probability is estimated:

$$WP = 0.5 ( erf ( \frac{Rating 1 - Rating 2}{\sqrt{2 ( Vol {1}^{2} + Vol {2}^{2} )}} ) + 1 )$$

Where Rating1 & Vol1 are the rating and volatility of the task performer being compared to, and Rating2 & Vol2 are the rating and volatility of the task performer whose win probability is being calculated. Erf is the “error function”.

The probability of the task performer getting a higher score than another task performer in the competition (WPi for i from 1 to NumCoders) is estimated. The expected rank of the task performer is calculated:

$$ERank = .5 + {\sum }_{i = 1}^{NumCoders} {WP}_{i}$$

The expected performance of the task performer is calculated:

$$EPerf = - Φ ( \frac{Erank - .5}{Numcoders} )$$

Where Φ is the inverse of the standard normal function.

The actual performance of each task performer is calculated:

$$APerf = - Φ ( \frac{Arank - .5}{NumCoders} )$$

Where ARank is the actual rank of the task performer in the competition based on score (1 for first place, NumCoders for last). If the task performer tied with another task performer, the rank is the average of the positions covered by the tied task performers.

The performed as rating of the task performer is calculated:

PerfAs=OldRating+CF*(APerf−Eperf)

The weight of the competition for the task performer is calculated:

$$Weight = \frac{1}{( 1 ( \frac{.42}{TimesPlayed + 1} + .18 ) )} - 1$$

Where TimesPlayed is the number of times the task performer has been rated before. To stabilize the higher rated members, the Weight of members whose rating is between 2000 and 2500 is decreased 10% and the Weight of members whose rating is over 2500 is decreased 20%.

A cap is calculated:

$$Cap = 150 + \frac{1500}{TimesPlayed + 2}$$

The new volatility of the task performer is calculated:

$$NewVolatility = \sqrt{\frac{{( NewRating - OldRating )}^{2}}{Weight} + \frac{{OldVolatility}^{2}}{Weight + 1}}$$

The new rating of the task performer is calculated:

$$NewRating = \frac{Rating + Weight * PerfAs}{1 + Weight}$$

If |NewRating−Rating|>Cap the NewRating is adjusted so it is at most Cap different than Rating.

In some embodiments, a reliability rating also may be used to measure the reliability of the task performer to deliver optimizations in competitions in which the task performer has committed. This may be helpful for determining the likelihood that optimizations will be submitted based on the commitments by the task performers.

What is claimed is:

1. A system for competitive performance of marketing tasks, comprising:
a user module for publishing performance statistics of task performers;
a competition module for facilitating selection of task performers for participation in a competition;
an interface server for collecting response to the task performance of each selected competitor;
a performance module for updating the performance statistics for task performers based on the response; and
an administration module for compensating task performers based on the published performance statistics.

2. The system of claim 1 wherein the task comprises advertising placement.

3. The system of claim 1 wherein the task comprises web site optimization.

4. The system of claim 1 wherein the task performers are selected based on published performance statistics.

5. The system of claim 1 further comprising a backoffice component for determining content to show to browsers.

6. The system of claim 5 wherein the backoffice component determines content provided by a web site.

7. The system of claim 5 wherein the backoffice component comprises a content delivery system.

8. The system of claim 5 wherein the backoffice component comprises a web server.

9. The system of claim 5 wherein the backoffice component is in communication with a web server for determining content to show to browsers.

10. The system of claim 5 wherein the competition module receives direction from task performers and communicates the direction to the backoffice component.

11. The system of claim 5 wherein the backoffice component determines and reports performance statistics used to evaluate the performance of task performers.

12. The system of claim 11 wherein the backoffice component reports statistics to the competition server.

13. The system of claim 5, wherein the backoffice component determines advertisements that are provided by web sites.

14. The system of claim 13 wherein the backoffice component determines advertisements that are provided by web sites based on the selections of task performers.

15. The system of claim 13 wherein the backoffice component comprises an advertising network.

16. The system of claim 13, further comprising a purchasing component for the specification and purchasing of advertising content, wherein the purchasing component is in communication with the backoffice component for purchasing advertisements on sites served by the backoffice component.

17. The system of claim 13 further comprising a campaign server for allowing multiple task performers to select and purchase ad placements.

18. The system of claim 19 wherein the campaign server can manage the allocation of ad budgets and placements.

19. The system of claim 20 wherein the campaign server can manage payments to an advertising network.

20. A method for performing marketing tasks by competition, comprising:
publishing performance statistics of task performers;
facilitating selection of task performers for participation in a competition based on the published performance statistics;
facilitating task performance by each selected competitors and collecting response to the task performance of each selected competitor;
updating the published performance statistics based on the response; and
compensating the task performers based on the published performance statistics.
